(19) United States
(12) Patent Application Publication
(10) Pub. No.: US 2025/0272517 A1
(43) Pub. Date: Aug. 28, 2025

(54) SYSTEMS AND METHODS FOR USING MACHINE-LEARNING TO EXTRACT AND PROCESS AUDIO DATA

(71) Applicant: STATS LLC, Chicago, IL (US)

(72) Inventors: Hema RENUKAIAH, Bangalore (IN); Pavithra DHANASEKARAN, Bangalore (IN); Arun SIVARAMAN, Bangalore (IN); Christian MARKO, Graz (AT); Patrick Joseph LUCEY, Chicago, IL (US)

(73) Assignee: STATS LLC, Chicago, IL (US)

(21) Appl. No.: 19/064,094

(22) Filed: Feb. 26, 2025

Related U.S. Application Data
(60) Provisional application No. 63/638,111, filed on Apr. 24, 2024.

(30) Foreign Application Priority Data
Feb. 27, 2024 (IN) 202411014105

(51) Int. Cl. G06F 40/58

(52) U.S. Cl. CPC G06F 40/58

(57) ABSTRACT

A method for extracting and processing audio data may include receiving one or more packets of multimedia content. The one or more packets of multimedia content may comprise audio data. The method may further include extracting the audio data from the one or more packets of multimedia content. The audio data may comprise verbal speech in a first language. The method may further include converting the audio data into first text data in the first language based on the verbal speech in the first language. The method may further include providing the first text data to a generative machine-learning model. The generative machine-learning model may have been trained to translate the first text data in the first language to a second language and generate second text data in the second language. The method may further include transmitting, to a user interface, the second text data in the second language.

### CROSS-REFERENCE TO RELATED APPLICATIONS

This application claims priority to Indian Application No. 202411014105, filed Feb. 27, 2024, and U.S. Provisional Application Ser. No. 63/638,111, filed Apr. 24, 2024, each of which is hereby incorporated by reference in its entirety.

### TECHNICAL FIELD

Various embodiments of this disclosure relate generally to machine-learning-based techniques for generating text data, and, more particularly, to systems and methods for extracting and processing audio data.

### BACKGROUND

Relying solely on manual commentary for sports programs, or live broadcasts, poses certain challenges and limitations that may impact the quality and accessibility of the content. Manual commentary is typically provided in limited alternative languages which limits the broadcast's accessibility to a wider audience that may speak a language other than the original broadcast language.

Unless otherwise indicated herein, the materials described in this section are not prior art to the claims in this application and are not admitted to be prior art, or suggestions of the prior art, by inclusion in this section.

### SUMMARY OF THE DISCLOSURE

In one aspect, an exemplary embodiment of a method for extracting and processing audio data may include receiving one or more packets of multimedia content. The one or more packets of multimedia content may comprise audio data. The method may further include extracting the audio data from the one or more packets of multimedia content. The audio data may comprise verbal speech in a first language. The method may further include converting the audio data into first text data in the first language based on the verbal speech in the first language. The method may further include providing the first text data to a generative machine-learning model. The generative machine-learning model may have been trained to translate the first text data in the first language to a second language and generate second text data in the second language. The method may further include transmitting, to a user interface, the second text data in the second language.

In another aspect, an exemplary embodiment of a system for extracting and processing audio data may include a memory storing instructions and a generative machine-learning model that may have been trained to translate first text data in a first language to a second language and generate second text data in the second language. The system may further include a processor operatively connected to the memory and configured to execute the instructions to perform operations. The operations may include receiving one or more packets of multimedia content. The one or more packets of multimedia content may include audio data. The operations may further include extracting the audio data from the one or more packets of multimedia content. The audio data may comprise verbal speech in the first language. The operations may further include converting the audio data into the first text data in the first language based on the verbal speech in the first language. The operations may further include providing the first text data to the generative machine-learning model. The operations may further include transmitting the second text data in the second language.

In a further aspect, an exemplary embodiment of a method for extracting and processing audio data that may include receiving one or more packets of multimedia content. The one or more packets of multimedia content may comprise audio data. The method may further include extracting the audio data from the one or more packets of multimedia content. The audio data may comprise verbal speech in a first language. The method may further include converting the audio data into first text data in the first language based on the verbal speech in the first language. The method may further include providing the first text data to a rephrasing machine-learning model. The rephrasing machine-learning model may have been trained to rephrase the first text data in the first language to one or more strings of text data in a second language and generate rephrased second text data in the second language. The method may further include transmitting, to a user interface, the rephrased second text data in the second language.

Additional objects and advantages of the disclosed aspects will be set forth in part in the description that follows, and in part will be apparent from the description, or may be learned by practice of the disclosed aspects. The objects and advantages of the disclosed aspects will be realized and attained by means of the elements and combinations particularly pointed out in the appended claims.

It is to be understood that both the foregoing general description and the following detailed description are exemplary and explanatory only and are not restrictive of the disclosed aspects, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed aspects.

FIG. 1 depicts an exemplary environment for using a machine-learning model to extract and process audio data, according to one or more embodiments.

FIG. 2 depicts a data flow diagram, according to one or more embodiments.

FIG. 3 depicts a dataflow diagram for merging converted audio data with video data, according to one or more embodiments.

FIG. 4 depicts a flowchart of an exemplary method of extracting and processing audio data, according to one or more embodiments.

FIG. 5 depicts a flowchart of an exemplary method of generating live commentary using a generative machine-learning model, according to one or more embodiments.

FIG. 6 depicts a flowchart of an exemplary method of generating translated live commentary using a generative machine-learning model, according to one or more embodiments.

FIG. 7 depicts a flow diagram for training a machine-learning model, according to one or more embodiments.

FIG. 8 depicts an example of a computing device, according to one or more embodiments.

Notably, for simplicity and clarity of illustration, certain aspects of the figures depict the general configuration of the various embodiments. Descriptions and details of well-known features and techniques may be omitted to avoid unnecessarily obscuring other features. Elements in the figures are not necessarily drawn to scale; the dimensions of some features may be exaggerated relative to other elements to improve understanding of the example embodiments.

### DETAILED DESCRIPTION OF ASPECTS

Various aspects of the present disclosure relate generally to techniques for using machine-learning for processing audio data, such as for sports applications. Manual commentary quality and style can vary significantly between commentators, leading to inconsistencies in the coverage during a broadcast (e.g., of a sporting event, news broadcast, and the like). Delivering sports commentary in a variety of languages for international sporting events, for example, may be logistically challenging and costly. It may require a team of bilingual/multilingual commentators, which may result in additional expense and potential logistical difficulties. Further, manual commentary may primarily cater to auditory information, making it less accessible to individuals with hearing impairments.

In a particular example, a translation may be generated using a speech-to-text approach (e.g., human commentary mapped to text). However, in sports commentary, or other applications, player names, team names, key events or tactical descriptions may not be well translated. For example, the player name “Messi” may be translated as “messy,” or the like. Key events such as “counter-attack” may be rendered as “counteract,” or the like.

Therefore, the present disclosure provides for machine-learning based techniques of extracting and processing audio data. Additionally, using artificial-intelligence based techniques for language translation, may allow for real-time translation of commentary into multiple languages, which may ensure that a broader audience can access and understand the content. The logistical and financial challenges associated with hiring and managing a team of bilingual commentators may be reduced also. More specifically, machine-learning based techniques of extracting and processing audio data disclosed herein provide for faster, more accurate, more efficient, and tailored processing of audio data, in comparison to conventional techniques. For example, techniques disclosed herein utilize generative artificial intelligence to localize audio data in real-time (e.g., within approximately 1 second) or near-real time (e.g., within approximately 3 seconds). Techniques disclosed herein further reduce the computational resources required for such processing by, for example, leveraging machine-learning training to reduce just-in-time processing loads.

Further, the use of artificial intelligence may be tailored to individual preferences, allowing viewers (e.g. end users) to customize their commentary experience. Users may choose specific languages, focus on particular aspects of a sports game, or access additional information, which may enhance their overall engagement with the broadcast content. Still further, artificial intelligence, or machine-learning, generated commentary may be easily converted into text and displayed as captions or subtitles, which may ensure accessibility for individuals with hearing impairments, allowing them to follow and enjoy a broadcast in real-time without relying solely on auditory information. Such conversions may be performed using data generated during processing of the audio data, allowing such conversions to be implemented in real-time or near real-time.

As discussed herein, one or more artificial intelligence models or machine-learning models may be trained to understand a sports language (e.g., a natural language model, or the like). Accordingly, machine-learning models disclosed herein are sports machine-learning models. Such sports machine-learning models may be trained using sports related data (e.g., tracking data, event data, etc., as discussed herein). A sports machine-learning model trained to understand a sports language based on sports related data may be trained to adjust one or more weights, layers, nodes, biases, and/or synapses based on the sports related data. A sports machine-learning model may include components (e.g., a weights, layers, nodes, biases, and/or synapses) that collectively associate one or more of: a player with a team or league; a team with a player or league; a score with a team; a scoring event with a player; a sports event with a player or team; a win with a player or team; a loss with a player or team; and/or the like. A sports machine-learning model may correlate sports information and statistics in a competition landscape. A sports machine-learning model may be trained to adjust one or more weights, layers, nodes, biases, and/or synapses to associate certain sports statistics in view of a competition landscape. For example, a win indicator for a given team may automatically correlated with a loss indicator for an opposing team. As another example, a score static may be considered a positive attribution for a scoring team and a negative attribution for a team being scored upon. As another example, a given score may be ranked against one or more scores based on a relative position of the score in comparison to the one or more other scores.

A sports machine-learning model may be trained based on sports tracking and/or event data, as discussed herein. Such data may include player and/or object position information, movement information, trends, and changes. For example, a sports machine-learning model may be trained by modifying one or more weights, layers, nodes, biases, and/or synapses to associate given positions in reference to the playing surface of venue and/or in reference to none or more agents. As another example, a sports machine-learning model may be trained by modifying one or more weights, layers, nodes, biases, and/or synapses to associate given movement or trends in reference to the playing surface of venue and/or in reference to none or more agents. As another example, a sports machine-learning model may be trained by modifying one or more weights, layers, nodes, biases, and/or synapses to associate sporting events with corresponding time boundaries, teams, players, coaches, officials, and environmental data associated with a location of corresponding sporting events.

A sports machine-learning model may be trained by modifying one or more weights, layers, nodes, biases, and/or synapses to associate position, movement, and/or trend information in view of a sports target. A sports target may be a score related target (e.g., a score, a goal, a shot, a shot count, a point, etc.), a play outcome (e.g., a pass, a movement of an object such as a ball, player positions, etc.), a player position, and/or the like. A sports machine-learning model may be trained in view sports targets, play outcomes, player positions, and/or the like associated with a given sport (e.g., soccer, American football, basketball, baseball, tennis, golf, rugby, hockey, a team sport, an individual sport, etc.). For example, a soccer based sports machine-learning model may be trained to correlate or otherwise associate player position information in reference to a soccer pitch. The soccer based sports machine-learning model may further be trained to correlate or otherwise associate sports data in reference to a number of players and sports targets specific to soccer.

According to aspects, one or more given sports machine-learning model types (e.g., generative learning, linear regression, logistic regression, random forest, gradient boosted machine (GBM), deep learning, graph neural networks (GNN) and/or a deep neural network) may be determined based on attributes of a given sport for which the one or more machine-learning models are applied. The attributes may include, for example, sport type (e.g., individual sport vs. team sport), sport boundaries (e.g., time factors, player number factors, object factors, possession periods (e.g., overlapping or distinct), playing surface type (e.g., restricted, unrestricted, virtual, real, etc.) player positions, etc.

According to aspects, a sports machine-learning model may receive inputs including sports data for a given sport and may generate a matrix representation based on features of the given sport. The sports machine-learning model may be trained to determine potential features for the given sport. For example, the matrix may include fields and/or sub-fields related to player information, team information, object information, sports boundary information, sporting surface information, etc. Attributes related to each field or sub-field may be populated within the matrix, based on received or extracted data. The sports machine-learning model may perform operations based on the generated matrix. The features may be updated based on input data or updated training data based on, for example, sports data associated with features that the model is not previously trained to associate with the given sport. Accordingly, sports machine-learning models may be iteratively trained based on sports data or simulated data.

As used herein, a “machine-learning model” or “artificial intelligence model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistic regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

While several of the examples herein involve certain types of machine-learning, it should be understood that techniques according to this disclosure may be adapted to any suitable type of machine-learning. It should also be understood that the examples above are illustrative only. The techniques and technologies of this disclosure may be adapted to any suitable activity.

While sports broadcasts and various aspects relating to sports broadcasts (e.g., game commentary) are described in the present aspects as illustrative examples, the present aspects are not limited to such examples. For example, the present aspects can be implemented for other types of broadcasts or commentary, such as, for example, news broadcasts, prerecorded television programs, streaming multimedia content, and other events where language translation may be customary.

While sports broadcasts and various aspects relating to sports broadcasts (e.g., game commentary) may be described in relation to a given sport, it will be understood that such aspects may be implemented for any applicable sport such as, but not limited to, team sports, individual sports, soccer, basketball, American football, rugby, golf, tennis, hockey, cricket, and/or the like.

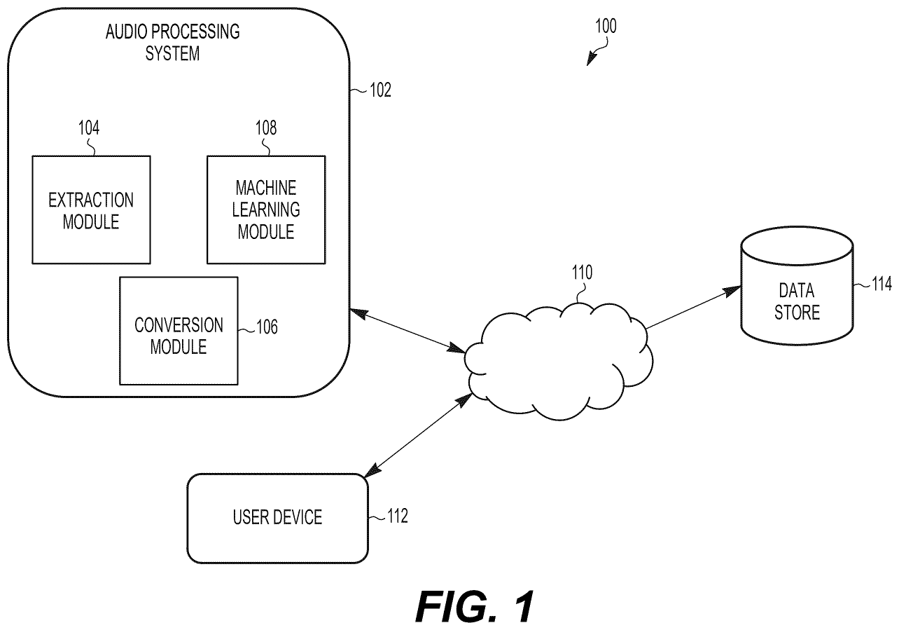

FIG. 1 depicts an exemplary environment 100 that may be utilized with techniques presented herein. One or more user device(s) 112 may communicate across an electronic network 110. The one or more user device(s) 112 may be associated with a user, e.g., a user that is viewing a broadcast, an administrator of one or more components of environment 100, and/or the like. As will be discussed in further detail below, one or more audio processing system(s) 102 may communicate with one or more of the other components of the environment 100 across electronic network 110.

The user device(s) 112 may be configured to enable a user to access and/or interact with other systems in the environment 100. For example, the user device(s) 112 may each be a computer system such as, for example, a desktop computer, a mobile device, a tablet, etc. In some embodiments, the user device(s) 112 may include one or more electronic application(s), e.g., a program, plugin, browser extension, etc., installed on a memory of the user device(s) 112. In some embodiments, the electronic application(s) may be associated with one or more of the other components in the environment 100. For example, the electronic application(s) may include one or more of system control software, system monitoring software, software development tools, etc.

In various embodiments, the environment 100 may include a data store 114 (e.g., database). The data store 114 may include a server system and/or a data storage system such as computer-readable memory such as a hard drive, flash drive, disk, etc. In some embodiments, the data store 114 includes and/or interacts with an application programming interface for exchanging data to other systems, e.g., one or more of the other components of the environment. The data store 114 may include and/or act as a repository or source for storing text data, audio data, generated text data, and the like (e.g., a user of user device 112 or any of the other components of environment 100).

In some embodiments, the components of the environment 100 are associated with a common entity, e.g., a service provider, an account provider, or the like. For example, in some embodiments, audio processing system 102 and data store 114 may be associated with a common entity. In some embodiments, one or more of the components of the environment is associated with a different entity than another. For example, audio processing system 102 may be associated with a first entity (e.g., a service provider) while data store 114 may be associated with a second entity (e.g., a storage entity providing storage services to the first entity). The systems and devices of the environment 100 may communicate in any arrangement. As will be discussed herein, systems and/or devices of the environment 100 may communicate in order to one or more of generate, train, or use a machine-learning model to process audio data, among other activities.

As discussed in further detail below, the audio processing system(s) 102 may one or more of (i) generate, store, train, communicate with, or use a machine-learning model configured to process audio data and generate text data. The audio processing system(s) 102 may include a machine-learning model and/or instructions associated with the machine-learning model, e.g., instructions for generating a machine-learning model, training the machine-learning model, using the machine-learning model etc. The audio processing system(s) 102 may include instructions for retrieving data, adjusting data, e.g., based on the output of the machine-learning model, and/or operating a display of the user device(s) 112 to output the generated text data or merged audio and video data, e.g., as adjusted based on the machine-learning model. The audio processing system(s) 102 may include training data, e.g., text data, and may include ground truth, e.g., (i) training text data, (ii) training audio data, and (iii) training language data to generate second text data in a second language.

As depicted in FIG. 1, audio processing system(s) 102 may include extraction module 104. In various embodiments, extraction module 104 is configured to extract audio data from one or more packets of multimedia content. In examples, the audio data may include verbal speech spoken in a first language. In various embodiments, commentary for a broadcast (e.g., a broadcast of a sporting event), may be included as audio data within the one or more packets of multimedia content and may be in a first language. The audio data may, for example, may be included as a sub-file of the multimedia content packet. In one particular example, a football game broadcast on live television may include commentary on the game in English. Therefore, the audio data would include verbal speech spoken in English. The one or more packets of multimedia content may be received by audio processing system(s) 102 over network 110. The audio data may be in a first format (e.g., a format associated with the multimedia content packet).

Audio processing system(s) 102 may also include conversion module 106. In various embodiments, conversion module 106 may be configured to convert the audio data from the multimedia content to first text data in the first language based on the verbal speech in the first language. In examples, this may include parsing the audio data to generate or transcribe written text that represents what is spoken in the verbal speech. As in the particular example above, the audio data may include verbal speech in the English language, and therefore the first text data may include written text that may generally correspond (e.g., word for word) to what is spoken. The first text data may be in any suitable format, such as a text file, or may be represented as ASCII characters, hexadecimal characters, or the like. The first text data may be stored in data store 114 and retrieved by components of audio processing system 102 for use. According to various embodiments, the audio data in the first format may first be converted into a second format (e.g., a format associated with conversion module 106) prior to converting the audio data into the first text data in the first language. As depicted in FIG. 1, audio processing system(s) 102 may also include machine-learning module 108. In some embodiments, a system or device other than the audio processing system(s) 102 is used to generate and/or train the machine-learning model. For example, such a system may include instructions for generating the machine-learning model, the training data and ground truth, and/or instructions for training the machine-learning model. A resulting trained-machine-learning model may then be provided to the audio processing system(s) 102.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between text data such that the trained machine-learning model is configured to generate second text data in a second language (e.g., to translate a first set of text data into a second set of text data in a second language).

In various embodiments, the variables of a machine-learning model may be interrelated in any suitable arrangement in order to generate the output. For example, in some embodiments, the machine-learning model may include audio processing architecture that is configured to identify, isolate, and/or extract features in one or more of audio data and/or text data. For example, the machine-learning model may include one or more convolutional neural network (“CNN”) configured to identify features in the text and/or audio data, and may include further architecture, e.g., a connected layer, neural network, etc., configured to determine a relationship between the identified features in order to determine an accurate translation that accounts for context in the verbal speech.

In some embodiments, the machine-learning model of the audio processing system 102 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive a sequence of text data in a first language as input, and generate second text data in another language.

According to various embodiments, conversion module 106 may include and/or communicate with machine-learning module 108 and/or may include a conversion machine-learning model. Machine-learning module 108 and/or conversion machine-learning model (referred to as “conversion machine-learning model” in this paragraph for simplicity) may be trained to convert sports audio data into the first text data in the first language. In various embodiments, terms that have multiple meanings in a second language may be flagged by a conversion machine-learning model or one or more components of audio processing system 102. In embodiments, such flagged terms may be processed by the conversion machine-learning model (or a specific component thereof) so that a term that may have a highest “sports term score” is selected. As such, each term extracted for translation may be assigned a sports term score, and the term with the highest score may be selected. In one embodiment, a transformer-based machine-learning model (e.g., GPT, BERT, or the like) may score words based on context. In the example of a sports machine-learning model, the context may be informed by the sports language, as described herein. As such, the model may process an input sentence in a source language and may assign a weight to each word based upon a relevance to other words in the sentence (e.g., in terms of sports). Using the contextual relationships between the words, the model may predict the most appropriate words in the target language (e.g., a selected language). Such context aware scoring may improve accuracy of the translation (e.g., conversion).

The conversion machine-learning model may be trained using training data that includes historical or simulated sports broadcast audio data, sports text data, sport related terms, sport related articles, and/or the like. Accordingly, the conversion machine-learning model may be trained to recognize sports related audio data and identify sports related words and/or terms based on the training data. The conversion machine-learning model may receive, as an input, the audio data and may output the first text data in the first language based on such sports related training. Accordingly, in accordance with the techniques disclosed herein, machine-learning technology and/or machine-learning models may be improved to efficiently and more accurately generate sports related outputs based on the training and inputs discussed herein.

According to embodiments of the disclosed subject matter, a machine learning model may be trained or re-trained (e.g., refined/fine-tuned) using a sports specific training dataset (e.g., as discussed in relation to the sports machine-learning models herein). The sports specific training dataset may include sport specific information, tactical concepts, formations, league specific information, team specific information, and/or player specific information related to a given match or plurality of matches. By training and/or refining the machine learning model using a sports specific training dataset, the machine learning model may be improved to identify speech more accurately. Based on such training and/or refining, weights, nodes, synapses, biases, layers and/or the like of the machine learning model may be tuned to identify sports related speech. As soccer examples, using traditional models, “Messi” might be transcribed as “messy” or “Macey,” “Kante” might end up as “can't” or “candy,” “offside trap” might be recorded as “aside trap” or “offside wrap,” “counter-attack” might be rendered as “counteract” or even just “counter attack” with missed syllables, “false nine” could be misrecognized as “falling nine” or “foul nine,” each altering the intended meaning. However, using a sports specific training dataset, as described herein, the weights, nodes, synapses, biases, layers and/or the like of the corresponding machine learning model may be trained to weight or bias outputs in favor of the sports related speech instead of the alternative, non-sports related speech.

In further embodiments, contextual biasing may be used to train one or machine-learning models. In various embodiments, external, domain-specific (e.g., sports language specific) language models may be integrated during a decoding phase (e.g., using shallow fusion). The resulting trained model may be pre-loaded with sports-specific vocabulary that may be updated dynamically with sports context (e.g., team names, player statistics, and the like). In embodiments, contextual biasing may be used to fine-tune one or more machine-learning models discussed herein. Contextual biasing may therefore enhance one or more machine-learning models by integrating specific vocabulary during training or fine-tuning of the one or more models to prioritize domain-specific terms or language. Techniques such as text injection may use unpaired text data to guide model attention toward target phrases. Prompt engineering may focus on correcting errors in rare-word recognition through supervised learning. Such methods may adjust loss functions or attention weights to emphasize contextual cues, thereby improving accuracy on terms without lowering general performance of the machine-learning models.

As depicted in FIG. 1, environment 100 may also include electronic network 110. In various embodiments, the electronic network 110 may be a wide area network (“WAN”), a local area network (“LAN”), personal area network (“PAN”), or the like. In some embodiments, electronic network 110 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

Although depicted as separate components in FIG. 1, it should be understood that a component or portion of a component in the environment 100 may, in some embodiments, be integrated with or incorporated into one or more other components. In another example, the audio processing system 102 may be integrated in a data storage system. The data storage system may be configured to communicate and/or receive/send data across electronic network 110 to other components of environment 100. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized to process audio data are discussed in further detail in the methods below. In the following methods, various acts may be described as performed or executed by a component from FIG. 1, such as the audio processing system 102, the user device 112, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

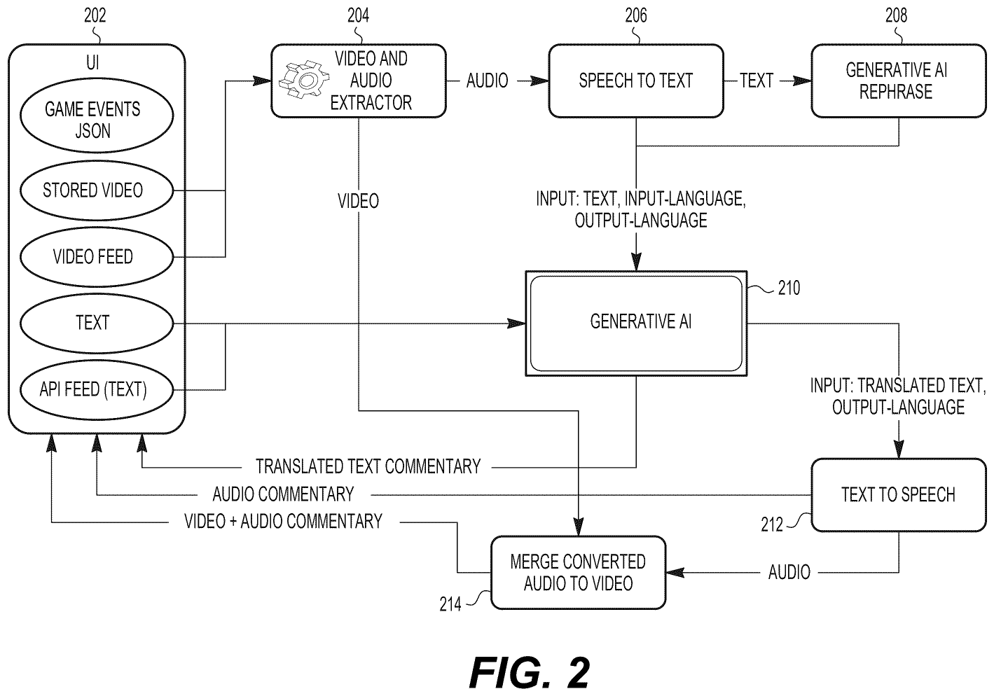

FIG. 2 depicts a data flow diagram, such as in the processing of audio data. As illustrated, multimedia content, such as game events (e.g., JavaScript Object Notation (JSON) file(s)), stored video content, a video feed, application programming interface (API) feed, and/or the like, may be provided via a content resource 202 which may be an automated system component or user interface. Video and audio extractor 204 may then extract audio data from the multimedia content as described above (e.g., in reference to conversion module 106 and/or machine-learning module 108). The audio data is then converted via a speech to text 206 process into text data.

In various embodiments, the text data may be provided to a rephrasing machine-learning model 208 (e.g., a generative artificial intelligence rephrase module). This rephrasing machine-learning model 208 may be trained to rephrase the text data in a first language to one or more strings of text data in a second language and generate rephrased second text data in the second language. In this way, context of the verbal speech, as well as word meaning differences between languages, may be taken into account. In one particular example, a specific word in English may not have a suitable equivalent word in Spanish. While a literal translation of the English word or phrase may be possible, the meaning, once translated into Spanish, may be different, possibly resulting in an inaccurate translation. Therefore, as in this particular example, the rephrasing machine-learning model 208 may be trained to identify associations and patterns within the text and/or audio data, and apply those identified patterns to translating the text data into the second language with proper meaning and context. Training data (e.g., collected and/or simulated) may be provided to the rephrasing machine-learning model from a variety of sources (e.g., online libraries, content, multimedia content, sports libraries, sports terms tables, and the like) to train the rephrasing machine-learning model 208 to rephrase a set of text data (e.g., a phrase) to a string of text in another language that stays true to the meaning of the original language. The rephrased second text data may therefore be transmitted to a user interface, or may be utilized by other components of audio processing system 102.

The text data, having been converted via speech to text process 206, may be provided to artificial intelligence (AI) system 210 which may be a generative AI system. AI system 210 may execute a generative machine-learning model which may be trained using training data discussed herein in reference to one or more other machine-learning models. The AI system 210 may be trained to output localized text commentary based on the input data (e.g., from speech to text process 206 and/or rephrasing machine-learning model 208). Therefore, AI system 210 may output, or generate, a second set of text data which represents a translation of the input first text data to a second language that is localized based on one or more locales associated with the second language. Accordingly, the output of AI system 210 may be text corresponding to localized commentary for one or more locales associated with the second language. For example, AI system 210 may output text commentary that incorporates colloquial phrases, idioms, and/or sports terms or phrases based on the location of a user, metadata associated with the input data, a selected or predetermined user preference, or the like.

Thereafter, and as depicted in FIG. 2, the output second text data may be converted via a text to speech process 212, resulting in output audio data. In various embodiments, the speech generated from the second text data may be generated using an audio machine-learning model, such that the resulting verbal speech sounds generally similar to that of speech spoken by a human (e.g., similar to a broadcaster providing the original commentary received via content resource 202). The audio machine-learning model may be trained in accordance with techniques disclosed herein in reference to one or more machine-learning models. The audio machine-learning model may be trained using training data that includes historical or simulated text data, audio data, commentary, voice data, voice attribute data (e.g., pitch data, volume data, tone data, etc.).

As illustrated, the output audio data may then be merged with video data at 214 to create a translated version of the original multimedia content. In this way, the multimedia content presented to the user, in real-time or near real time, will generally appear and sound like the original broadcast, except in a language that the viewer has selected. According to embodiments, a delay may be added to the video track of the broadcast content received via content resource 202. The delay may be dynamically determined based on the amount of time that lapses between receiving the broadcast content via resources 202 and merging converted audio with the video content at 214. The delay may be dynamically updated from time to time to align the amount of time that lapses between receiving the broadcast content via resources 202 and merging converted audio with the video content at 214. For example, a delay determination component may sample the merged converted audio and video content at 214 and the broadcast content to determine a duration of time between the two. If the duration of time exceeds a delay threshold (e.g., more than or less than by the delay threshold amount), the delay determination component may output a new delay. Such sampling may be conducted periodically or may be triggered based on an indication of an outlier merge duration time (e.g., if more computational resources are expended to generate the merged content, a flag may trigger the delay determination component to determine the duration of time).

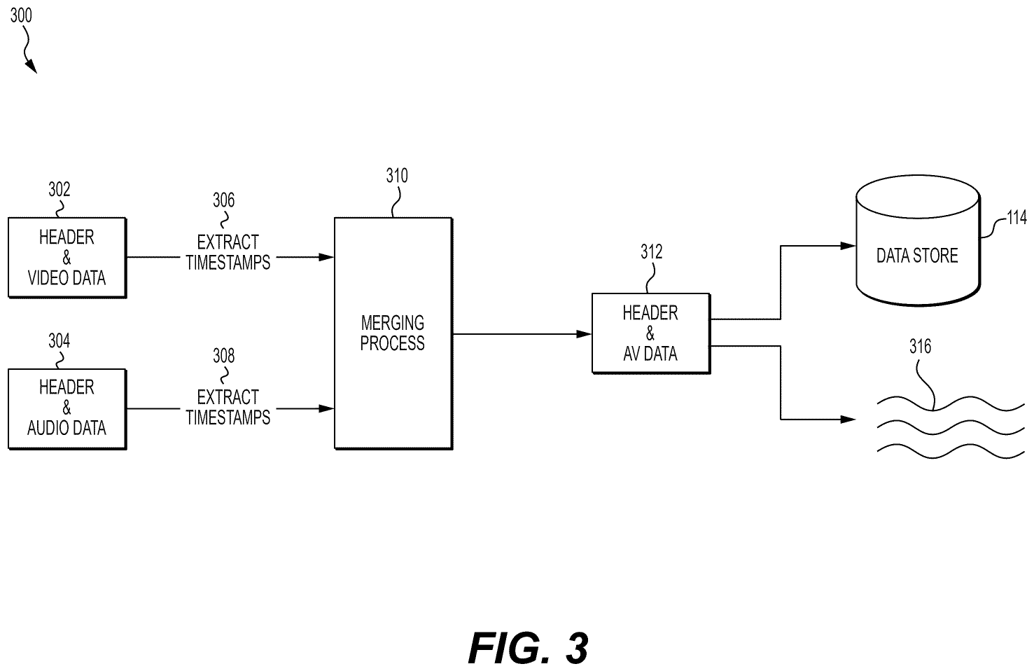

FIG. 3 depicts a dataflow diagram 300 for merging converted audio data with video data. As described above, with respect to FIG. 2, a packet of video data 302 may be merged with a packet of audio data 304, such as the translated audio data output by an audio machine-learning model. As illustrated in FIG. 3, a packet of video data 302 may include a header (e.g., including metadata) and video data (e.g., from a broadcast). A packet of audio data 304 may include a header and audio data (e.g., translated or generated audio data). In various embodiments, timestamps may be extracted 306 from the packet of video data 302 and timestamps may be extracted 308 from the packet of audio data 304. As described above, a delay may have been added to the video data (e.g., based on an output of the delay determination component). Therefore, and in examples, after the timestamps are extracted from the packet of video data 302 and the packet of audio data 304, the video data and the audio data may go through a merging process 310 to synchronize the video data with the audio data. In examples, an output of merging process 310 may be an Audio/Video (AV) data packet 312. The AV data packet 312 may include a header (e.g., including merged metadata) and the AV data (e.g., merged audio and video data). In various embodiments, the merged AV data packet 312 may be provided to a data store (such as data store 114, as also depicted in FIG. 1) for storage and/or later playback. In alternative embodiments, the AV data packet 312 may be provided to a live data stream 316, such as a broadcast. In examples, the AV data packet may be decoded by a user device in real-time (e.g., audio/video device) and overlaid over a live broadcast.

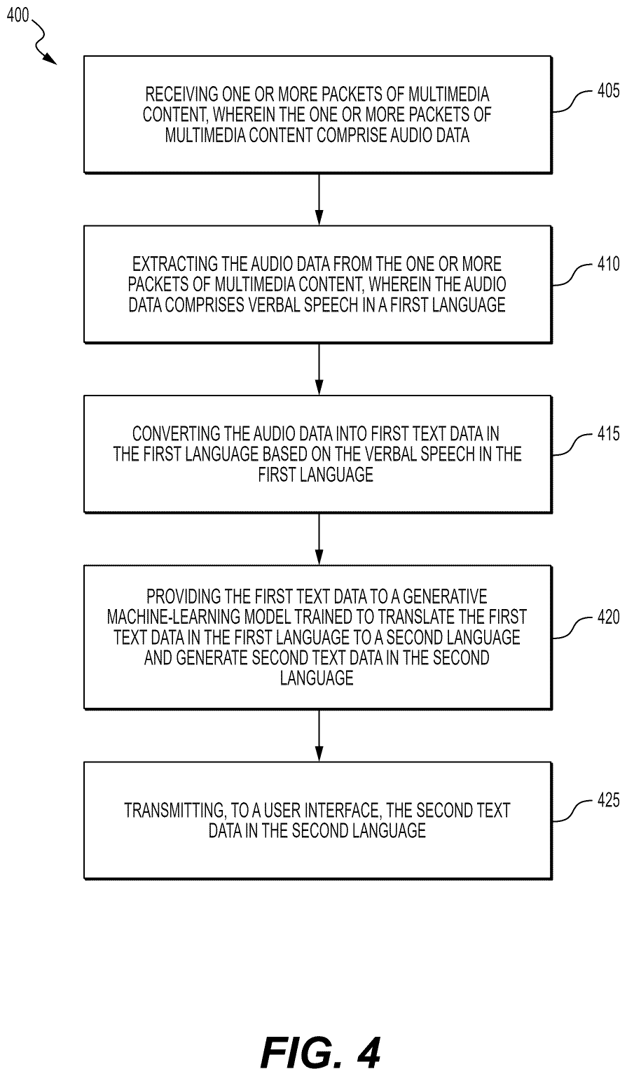

FIG. 4 illustrates an exemplary method 400 for extracting and processing audio data. Exemplary method 400 begins with step 405, wherein one or more packets of multimedia content are received (e.g., received via content resource 202 in FIG. 2). The multimedia content may comprise audio data. In various embodiments, the multimedia content may include one or more of audio data, video data, text data, story data, live feed data, or a combination thereof. The one or more packets may be in the form of JSON files, audio files, video files, story files, text files, or the like. In examples, the one or more packets of multimedia content may be received by an audio processing system, such as audio processing system 102 depicted in FIG. 1. The one or more packets of multimedia content may be received in real time (e.g., as the broadcast is occurring), or may be retrieved (e.g., by the audio processing system) from a data store, such as data store 114 depicted in FIG. 1. At step 410, the audio data is extracted from the one or more packets of multimedia content. The audio data may comprise verbal speech in a first language. In examples, the audio data may be extracted by an extraction module, such as extraction module 104 depicted in FIG. 1.

At step 415, the audio data may be converted into first text data in the first language based on the verbal speech in the first language. In examples, the audio data may be converted by a conversion module, such as conversion module 106 depicted in FIG. 1. In examples, the audio data may be converted into first text data using embedded or accompanying closed captioning data included in the one or more packets of multimedia content. In other examples, the audio data may be converted using a component of audio processing system 102, an artificial intelligence model, a speech to text process, or the like.

At step 420, the first text data may be provided to a generative machine-learning model. As described above, the machine-learning model may be trained to translate the first text data in the first language to a second language and to generate second text data in the second language. In examples, the generative machine-learning model may be executed by a machine-learning module, such as machine-learning module 108 depicted in FIG. 1. In various embodiments, machine-learning model may be trained to translate text data into a variety of different languages. In examples, a user may determine and select (e.g., via a user interface based input) a particular language, or languages, in which to translate a broadcast and may make that selection via a user device (e.g., such as user device 112 of FIG. 1), which selection or preference is then provided to the audio processing system. In other examples, the second text data generated by the machine-learning model may be translated into a format appropriate for individuals with hearing impairments.

In still other various embodiments, the first text data may be provided to a predictive machine-learning model. The predictive machine-learning model may be trained to identify language patterns in the first text data in the first language and then generate second text data in a second language based on the identified language patterns. The predictive machine-learning model may be trained using a training data set that includes historical or simulated text data in one or more languages, historical or simulated output text data, historical or simulated events, historical or simulated video feeds, and/or the like. As discussed herein, a generative AI based model may localize the text data for one or more locals associated with the second language. In examples where a translation of commentary may be needed in real time (e.g., to be provided almost concurrently with a live broadcast), it may be beneficial to use a predictive machine-learning model to identify language patterns and generate second text data before the first text data may be translated.

In an example, if a predictive machine-learning model has identified that a particular announcer often shouts “Goal!” after a soccer player scores a goal, the predictive machine-learning model may insert the phrase into the second text data, so that the predicted translation may be provided to the user in more or less real time. In other examples, the predictive machine-learning model may identify patterns of speech, including topics, phrases, word choice, situational context, and the like, in order to generate text data that will be as close as possible to an actual translation of the broadcast, favoring a translated broadcast that is airing concurrent with the original broadcast over an actual translation.

The predictive machine-learning model and/or the predictions discussed herein may be implemented via a prediction engine (e.g., which may be part of a tracking data system) may be configured to predict an underlying formation of a team. Mathematically, the goal of a role-alignment procedure may be to find the transformation A: {U₁, U₂, . . . , Uₙ}×M→[R₁, R₂, . . . , R_{K}], which may map the unstructured set U of N player trajectories to an ordered set (e.g., a vector) of K role-trajectories R. Each player trajectory itself may be an ordered set of positions Uₙ=[x_{s,n}]ₛ₌₁^{s} for an agent n∈[1, N] and a frame s∈[1, S]. In some embodiments, M may represent the optimal permutation matrix that enables such an ordering. The goal of the prediction engine may be to find the most probable set of [symbol] * of two-dimensional (2D) probability density functions:

$${ℱ}^{*} = arg {max}_{ℱ} P ( ℱ \vert R )$$

$$P ( x ) = {\sum }_{n = 1}^{N} P ( x \vert n ) P ( n ) = \frac{1}{N} {\sum }_{n = 1}^{N} {P}_{n} ( x )$$

In some embodiments, this equation may be transformed into one of entropy minimization where the goal is to reduce (e.g., minimize) the overlap (e.g., the KL-Divergence) between each role. As such, in some embodiments, the final optimization equation in terms of total entropy H may become:

$${ℱ}^{*} = arg {max}_{ℱ} {\sum }_{n = 1}^{N} H ( x \vert n )$$

The prediction engine may include a formation discovery module, a role assignment module, a template module, and/or the like each corresponding to a distinct phase of the prediction process. The formation discovery module may be configured to learn the distributions which maximize the likelihood of the data. The role assignment module may be configured to map each player position to a “role” distribution in each frame. Once the data has been aligned, the template module may be configured to map each learned formation a formation cluster template.

An organization computing system may receive tracking data and/or event data for a plurality of events across a plurality of seasons or across a match. For each event, the pre-processing agent may divide the event into a plurality of segments based on the event information. In some embodiments, the pre-processing agent may divide the event into a plurality of segments based on various events that may occur throughout the game. For example, the pre-processing agent may divide the event into a plurality of segments based on one or more events that include, but may not be limited to, red cards, ejections, technical fouls, flagrant fouls, player disqualifications, substitutions, halves, periods, quarters, overtime, and the like. Generally, each segment of a plurality of segments associated with an event may include an interval of a requisite duration (e.g., at least one minute of play, at least two minutes of play, etc.). Such requisite duration may allow an organization computing system to detect a team's formation.

Each segment may include a set of tracking data associated therewith. The player tracking data may be captured by tracking system, which may be configured to record the (x, y) positions of the players at a high frame rate (e.g., 10 Hz). In some embodiments, the player tracking data may further include single-frame event-labels (e.g., pass, shot, cross) in each frame of player tracking data. These frames may be referred to as “event frames.” As shown, the initial player tracking data may be represented as a set U of N player trajectories. Each player trajectory itself may be an ordered set of positions Uₙ=[x_{s,n}]ₛ₌₁^{s} for an agent n∈[1, N] and a frame s∈[1, S].

In some embodiments, the pre-processing agent may normalize the raw position data of the players. For example, the pre-processing agent may normalize the raw position data of the players in each segment so that all teams in the player tracking data are attacking from left to right and have zero mean in each frame. Such normalization may result in the removal of translational effects from the data. This may yield the set U′={U′₁, U′₂, . . . , U′ₙ}.

In some embodiments, the pre-processing agent may initialize cluster centers of the normalized data set for formation discovery with the average player positions. For example, average player positions may be represented by the set μ₀={μ₁, μ₂, . . . , μ₃}. The pre-processing agent may take the average position of each player in the normalized data and may initialize the normalized data based on the average player positions. Such initialization of the normalized data based on average player position may act as initial roles for each player to minimize data variance.

An organization computing system may learn a formation template from the tracking data for each segment. For example, the formation discovery module may learn the distributions which maximize the likelihood of the data. The formation discovery module may structure the initialized data into a single (SN)×d vector, where S may represent the total number of frames, N may represent the total number of agents (e.g., ten outfielders in the case of soccer, five players in the case of basketball, fifteen players in the case of rugby, etc.) and d may represent the dimensionality of the data (e.g., d=2).

The formation discovery module may then initiate a formation discovery algorithm. For example, the formation discovery module may initialize a K-means algorithm using the player average positions and execute to convergence. Executing the K-means algorithm to convergence produces better results than conventional approaches of running a fixed number of iterations.

The formation discovery module may then initialize a Gaussian Mixture Model (GMM) using cluster centers of the last iteration of the K-means algorithm. By parametrizing the distribution as a mixture of K Gaussians (with K being equal to the number of “roles,” which is usually also equal to N, the number of players), the formation discovery module may be able to identify an optimal formation that maximizes the likelihood of the data x. In other words, GMM may be configured to identify [symbol] *={P₁, P₂, . . . , P_{K}}, where [symbol] * may represent the optimal formation that maximizes the likelihood of the data x. Therefore, instead of stopping the process after the last iteration of the K-means algorithm, the formation discovery module may use GMM clustering, as the ellipse may better capture the shape of each player role compared to only a K-means clustering technique, which captures the spherical nature of each role's data cloud.

Further, GMMs are known to suffer from component collapse and become trapped in pathological solutions. Such collapse may result in non-sensible clustering, e.g., non-sensical outputs that may not be utilized. To combat this, the formation discovery module may be configured to monitor eigenvalues (λᵢ) of each of the components or parameters of the GMM throughout the expectation maximization process. If the formation discovery module determines that the eigenvalue ratio of any component becomes too large or too small, the next iteration may run a Soft K-Means (e.g., a mixture of Gaussians with spherical covariance) update instead of the full-covariance update. Such process may be performed to ensure that the eventual clustering output is sensible. For example, the formation discovery module may monitor how the parameters of the GMM are converging; if the parameters of the GMM are erratic (e.g., “out of control”), the formation discovery module may identify such erratic behavior and then slowly return the parameters back within the solution space using a soft K-means update.

### Hash-Table/Playbook Learning

For retrieval tasks using large amounts of data, an embodiment of the system uses a hash-table is required by grouping similar plays together, such that when a query is made, only the “most-likely” candidates are retrieved. Comparisons can then be made locally amongst the candidates and each play in these groups are ranked in order of most similar. Previous systems attempted clustering plays into similar groups by using only one attribute, such as the trajectory of the ball. However, the semantics of a play are more accurately captured by using additional information, such as information about the players (e.g., identity, trajectory, etc.) and events (pass, dribble, shot, etc.), as well as contextual information (e.g., if team is winning or losing, how much time remaining, etc.). Thus, embodiments of the present system utilize information regarding the trajectories of the ball and the players, as well as game events and contexts, to create a hash-table, effectively learning a “playbook” of representative plays for a team or player's behavior. The playbook is learned by choosing a classification metric that is indicative of interesting or discriminative plays. Suitable classification metrics may include predicting the probability of scoring in soccer or basketball (e.g., expected point value (“EPV”), or expected goal value (“EGV”). Other predicted values can also be chosen for performance variables, such as probability of making a pass, probability of shooting, probability of moving in a certain direction/trajectory, or the probability of fatigue/injury of a player.

The classification metric is used to learn a decision-tree, which is a coarse-to-fine hierarchical method, where at each node a question is posed which splits the data into groups. A benefit of this approach is that it can be interpretable and is multi-layered, which can act as “latent factors.”

### Bottom-Up Approach

In an embodiment of the system, a bottom-up approach to learning the decision tree is used. Various features are used in succession to discriminate between plays (e.g., first use the ball, then the player who is closest to the ball, then the defender etc.). By aligning the trajectories, there is a point of reference for trajectories relative to their current position. This permits more specific questions while remaining general (e.g., if a player is in the role of “point guard”, what is the distance from his/her teammate in the role of “shooting guard”, as well as the distance from the defender in the role of “point guard”). Using this approach avoids the need to exhaustively check all distances, which is enormous for both basketball and soccer.

### Top-Down Approach

In another embodiment of the system, a top-down approach to learning the decision tree is used. At a first step, all the plays are aligned to the set of templates. From this initial set of templates, the plays are assigned to a set of K groups (clusters), using all ball and player information, forming a Layer 1 of the decision tree. Back propagation is then used to prune out unimportant players and divide each cluster into sub-clusters (Layer 2). The approach continues until the leaves of the tree represent a dictionary of plays which are predictive of a particular task—e.g., goal-scoring (Layer 3).

### Personalization Using Latent Factor Models

In addition to raw trajectory information, in embodiments of the system, the plays in the database are also associated with game event information and context information. The game events and contexts in the database for a play may be inferred directly from the raw positional tracking data (e.g., a made or missed basket), or may be manually entered. Role information for players (can also be either inferred from the positional tracking data or entered separately. In embodiments of the system, a model for the database can then be trained by crafting features which encode game specific information based on the positional and game data and then calculating a prediction value (between 0 and 1) with respect to a classification metric (e.g., expected point value).

If there are a sufficient number of examples, the database model can be personalized for a particular player or game situation using those examples. In practice, however, a specific player or game situation may not be adequately represented by plays in the database. Thus, embodiments of the system find examples which are similar to the situation of interest—whether that be finding players who have similar characteristics or teams who play in a similar manner. A more general representation of a player and/or team is used, whereby instead of using the explicit team identity, each player or team is represented as a distribution of specific attributes. Embodiments of the system use the plays in the hash-table/playbook that were learned through the distributive clustering processes described above.

According to embodiments disclosed herein, a transformer neural network may receive inputs (e.g., tensor layers), where each input corresponds to a given player, team, or game. The transformer neural network may output generated predictions for one or more given players or teams based on such inputs. More specifically, the transformer neural network may output such generated predictions for a given player or team based on inputs associated with that given player or team and further based on the influence of one or more other players or teams. Accordingly, predictions provided by a transformer neural network, as discussed herein, may account for the influence of multiple players and/or teams when outputting a prediction for a given player and/or team.

The system described herein may include a machine-learning system configured to generate one or more predictions. In some examples, the system may incorporate a transformer neural network, graphical neural network, a recurrent neural network, a convolutional neural network, and/or a feed forward neural network. The system may implement a series of neural network instances (e.g., feed forward network (FFN) models) connected via a transformer neural network (e.g., a graph neural network (GNN) model). Although a transformer neural network is generally discussed herein, it will be understood that any applicable GNN, or other neural network that may utilize graphical interpretations, may be used to perform the techniques discussed herein in reference to a transformer neural network.

The transformer-based neural network may include a set of linear embedding layers, a transformer encoder, and a set of fully connected layers. The set of linear embedding layers may map component tensors of received inputs into tensors with a common feature dimension. The transformer encoder may perform attention along the temporal and agent dimensions. The set of fully connected layers may map the output embeddings from a last transformer layer of the transformer encoder into tensors with requested feature dimension of each target metric.

The transformer-based neural network may be configured to receive input features through the set of linear embedding layers. The input features may be received at different resolutions and over a time-series. The input features may relate to player features, team features, and/or game features. Input features may be input into the linear embedding layers as a tuple of input tensors. For example, a tuple of three tensors may be provided where the first tensor corresponds to all players in a match, a second tensor corresponds to both teams in the match, and the third tensor corresponds to a match state.

Examining the set of linear embedding layers, the linear embedding layers may contain a linear block for each input tensor of the tuple, and each block may map an input tensor to a tensor with a common feature dimension D. The output of the linear embedding layer may be a tuple of tensors, with a common feature dimension, which can be concatenated along the temporal and agent dimension to form a single tensor.

The transformer encoder may be configured to receive the single tensor from the linear embedding layers. The transformer encoder may be configured to learn an embedding that is configured to generate predictions on multiple actions for each agent (e.g., each player and/or team). The transformer encoder may include a series of axial transformer encoder layers, where each layer alternatively applies attention along the temporal and agent dimensions. The transformer encoder may include layers that alternate between temporally applying attention to sequences of action events, and applying attention spatially across the set of players and teams at each event time-step. The transformer encoder may include axial encoder layers configured to accept a tensor from the linear layers and apply attention along the temporal dimension, then along the agent dimension.

The attention mechanism that is implemented by the transformer encoder layers may have a graphical interpretation on a dense graph where each element is a node, and the attention mask is the inverse of the adjacency matrix defining the edges between the nodes (the absence of an attention mask thus implies a fully-connected graph). In the case of the axial attention used here, with the attention mask on the temporal (row) dimension, the nodes in the graph can be arranged in a grid, and each node may be connected to all nodes in the same column, and to all previous nodes in the same row. Attention, in this case, may be message-passing where each node can accept messages describing the state of the nodes in its neighborhood, and then update its own state based on these messages. This attention scheme may mean that when making a prediction for a particular player, the model may consider (i.e. attend to): the nodes containing the previous states of the player along the time-series; and the state nodes of the other players, team and the current game state in the current time-step. It may not be necessary for the nodes to be homogeneous—beyond having the same feature dimension—and thus a node that represents a player can accept messages from a node that represents at team, or from the player's strength node. The model may therefore learn the interactions between agents, and ensure consistent predictions for each agent along the time-series. The output of the transformer encoder layers may be a tensor (e.g., an output embedding).

The final layers of the transformer-based neural network may be the fully connected layers. These layers may map the output embedding of the final transformer layer of the transformer encoder to the feature dimension of each target metric. The final layers may output a target tuple that contains tensors for each of a set of modeled actions for each player and/or team. For example, the modeled action may be an empirical estimate of distributions for sport statistics such as number of shots taken, number of goals, number of passes, etc.

The training of the transformer-based neural network may include choosing a corresponding loss function for the distribution assumption of each output target. For example, the loss function may be the Poisson negative log-likelihood for a Poisson distribution, binary cross entropy for a Bernouilli distribution, etc. The losses may be computed during training according to the ground truth value for each target in the training set, and the loss values may be summed, and the model weights may be updated from the total loss using an optimizer. The learning rate may have been adjusted on a schedule with cosine annealing, without warm restarts.

Exemplary method 400 may continue to step 425, wherein the second text data in the second language is transmitted to a resource or user interface. In examples, the resource and/or user interface may be a component of a user device, such as user device 112 depicted in FIG. 1. In other examples, the second text data in the second language may be converted into translated audio data, and the translated audio data may be transmitted to the resource and/or user interface. In still other examples, the translated audio data may be merged with the video data of the one or more packets of multimedia content to generate translated multimedia content, and the translated multimedia content may be transmitted to the user interface. In any example, the text data, translated audio data, and/or the translated multimedia content may be configured to be displayed or output on the user interface (e.g., such as on user device 112 of FIG. 1), or may be stored for later use, such as within data store 114 depicted in FIG. 1.

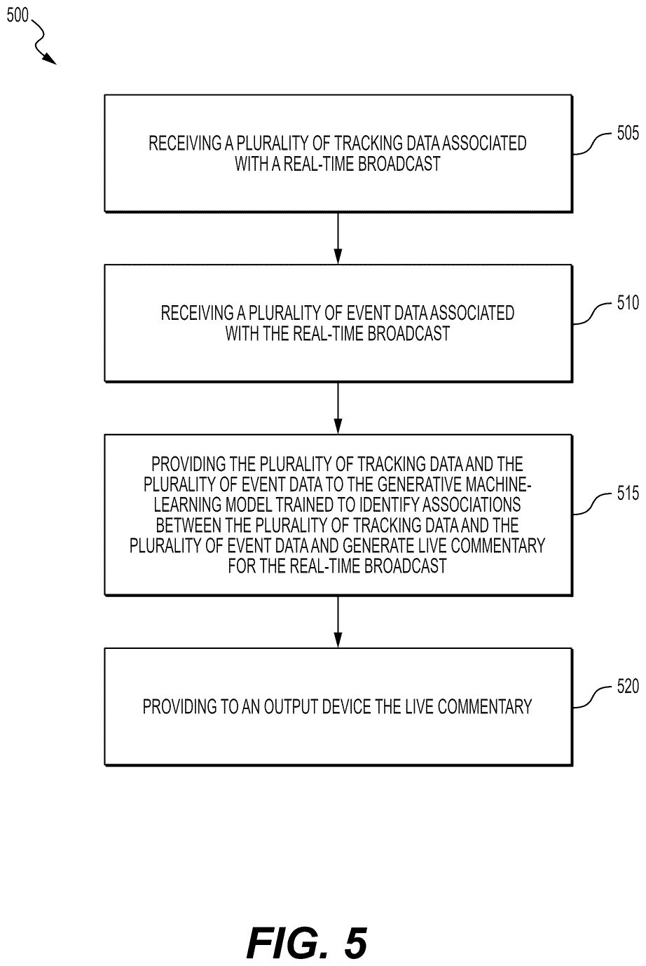

FIG. 5 depicts an exemplary method 500 of generating live commentary using a generative machine-learning model. At step 505, a plurality of tracking data associated with a real-time broadcast may be received. In various embodiments, a tracking system may be positioned in a venue and/or may be in communication (e.g., electronic communication, wireless communication, wired communication, etc.) with components located at the venue. For example, the venue may be configured to host a sporting event that includes one or more agents. The tracking system may be configured to capture the motions of one or more agents (e.g., players) on the playing surface, as well as one or more other agents (e.g., objects) of relevance (e.g., ball, puck, referees, etc.). In some embodiments, the tracking system may be an optically-based system using, for example, a plurality of fixed cameras, movable cameras, one or more panoramic cameras, etc. For example, a system of six calibrated cameras (e.g., fixed cameras), which project three-dimensional locations of players and a ball onto a two-dimensional overhead view of the playing surface may be used. In another example, a mix of stationary and non-stationary cameras may be used to capture motions of all agents on the playing surface as well as one or more objects or relevance. Utilization of such a tracking system may result in many different camera views of the playing surface (e.g., high sideline view, free-throw line view, huddle view, face-off view, end zone view, etc.).

In some embodiments, a tracking system may be used for a broadcast feed of a given match. For example, the tracking system may be used to generate game files to facilitate a broadcast feed of a given match. In such embodiments, each frame of the broadcast feed may be stored in a game file. A broadcast feed may be a feed that is formatted to be broadcast over one or more channels (e.g., broadcast channels, internet based channels, etc.). A game file may be converted from a first format (e.g., a format output by the one or more cameras or a different format than the format output by the one or more cameras) and may be converted into a second format (e.g., for broadcast transmission).

In some embodiments, a game file may further be augmented with other event information corresponding to event data, such as, but not limited to, game event information (pass, made shot, turnover, etc.) and context information (current score, time remaining, etc.). According to embodiments, event data may be generated manually or may be generated by a computing system in real time (e.g., within approximately 30 seconds of an event occurring), as discussed herein. A computing system may generate the event data by, for example, analyzing tracking data, and/or one or more other data types such as a video feed, excitement data, etc. The computing system may utilize a machine-learning model to determine when given tracking data or changes in tracking data (e.g., given player movements, object movements, changes in the same, etc.) correspond to an event (e.g., a scoring event, a penalty event, a possession based event, play type event, etc.). Event data may be automatically identified using a machine-learning trained to receive, as an input, a game file or a subset thereof and output game information and/or context information based on the input. The machine-learning model may be trained using supervised, semi-supervised, or unsupervised learning, in accordance with the techniques disclosed herein. The machine-learning model may be trained by analyzing training data using one or more machine-learning algorithms, as disclosed herein. The training data may include game files or simulated game files from historical games, simulated games, and/or the like and may include tagged and/or untagged data.

According to embodiments disclosed herein, event data may be generated based on tracking data and/or content feeds (e.g., in-venue video feeds, broadcast feeds, etc.). For example, tracking data may be generated by providing a content feed to one or more machine-learning models. The one or more machine-learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a prediction module to make predictions. The tracking data may be analyzed by the machine-learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sports events.

A tracking system may be configured to communicate with an organization computing system via a network. For example, the tracking system may be configured to provide the organization computing system with a broadcast stream of a game or event in real-time or near real-time via the network. As an example, the tracking system may provide one or more game files in a first format (e.g., corresponding to a format based on the components of the tracking system). Alternatively, or in addition, the tracking system or organization computing system may convert the broadcast stream (e.g., game files) into a second format, from the first format. The second format may be based on the organization computing system. For example, the second format may be a format associated with a data store.

A tracking data system may be configured to receive broadcast data from the tracking system and generate tracking data from the broadcast data. In some embodiments, the tracking data system may apply an artificial intelligence and/or computer vision system configured to derive player-tracking data from broadcast video feeds.

To generate the tracking data from the broadcast data, the tracking data system may, for example, map pixels corresponding to each player and ball to dots and may transform the dots to a semantically meaningful event layer, which may be used to describe player attributes. For example, the tracking data system may be configured to ingest broadcast video received from the tracking system. In some embodiments, the tracking data system may further categorize each frame of the broadcast video into trackable and non-trackable clips. In some embodiments, the tracking data system may further calibrate the moving camera based on the trackable and non-trackable clips. In some embodiments, the tracking data system may further detect players within each frame using skeleton tracking. In some embodiments, the tracking data system may further track and re-identify players over time. For example, the tracking data system may reidentify players who are not within a line of sight of a camera during a given frame. In some embodiments, the tracking data system may further detect and track an object across a plurality of frames. In some embodiments, the tracking data system may further utilize optical character recognition techniques. For example, the tracking data system may utilize optical character recognition techniques to extract score information and time remaining information from a digital scoreboard of each frame.

Such techniques assist in the tracking data system generating tracking data from the broadcast feed (e.g., broadcast video data). For example, the tracking data system may perform such processes to generate tracking data across thousands of possessions and/or broadcast frames. In addition to such processes, an organization computing system may go beyond the generation of tracking data from broadcast video data. Instead, to provide descriptive analytics, the organization computing system may be configured to map the tracking data to a semantic layer (e.g., events).

The tracking data system may be implemented using a machine-learning model. The machine-learning model may be trained using supervised, semi-supervised, or unsupervised learning, in accordance with the techniques disclosed herein. The machine-learning model may be trained by analyzing training data using one or more machine-learning algorithms, as disclosed herein. The training data may include game files or simulated game files from historical games, simulated games, historical or simulated feature representations, and/or the like and may include tagged and/or untagged data. The tagged data may include position information, movement information, object information, trends, agent identifiers, agent re-identifiers, etc.

A play-by-play module may be configured to receive play-by-play data from one or more third party systems. For example, the play-by-play module may receive a play-by-play feed corresponding to the broadcast video data. In some embodiments, the play-by-play data may be representative of human generated data based on events occurring within the game. Even though the goal of computer vision technology is to capture all data directly from the broadcast video stream, the referee, in some situations, is the ultimate decision maker in the successful outcome of an event. For example, in basketball, whether a basket is a 2-point shot or a 3-point shot (or is valid, a travel, defensive/offensive foul, etc.) is determined by the referee. As such, to capture these data points, the play-by-play module may utilize machine-learning outputs and/or manually annotated data that may reflect the referee's ultimate adjudication. Such data may be referred to as the play-by-play feed.

To help identify events within the generated tracking data, the tracking data system may merge or align the play-by-play data with the raw generated tracking data (which may include the game and time fields). The tracking data system may utilize a fuzzy matching algorithm, which may combine play-by-play data, optical character recognition data (e.g., shot clock, score, time remaining, etc.), and play/ball positions (e.g., raw tracking data) to generate the aligned tracking data.

Once aligned, the tracking data system may be configured to perform various operations on the aligned tracking system. For example, the tracking data system may use the play-by-play data to refine the player and ball positions and precise frame of the end of possession events (e.g., shot/rebound location). In some embodiments, the tracking data system may further be configured to detect events, automatically, from the tracking data. In some embodiments, the tracking data system may further be configured to enhance the events with contextual information.

For automatic event detection, the tracking data system may include a neural network system trained to detect/refine various events in a sequential manner. For example, the tracking data system may include an actor-action attention neural network system to detect/refine one or more of: shots, scores, points, rebounds, passes, dribbles, penalties, fouls, and/or possessions. The tracking data system may further include a host of specialist event detectors trained to identify higher-level events. Exemplary higher-level events may include, but are not limited to, plays, transitions, presses, crosses, breakaways, post-ups, drives, isolations, ball-screens, offside, handoffs, off-ball-screens, and/or the like. In some embodiments, each of the specialist event detectors may be representative of a neural network, specially trained to identify a specific event type. More generally, such event detectors may utilize any type of detection approach. For example, the specialist event detectors may use a neural network approach or another machine-learning classifier (e.g., random decision forest, SVM, logistic regression etc.).

While mapping the tracking data to events enables a player representation to be captured, to further build out the best possible player representation, the tracking data system may generate contextual information to enhance the detected events. Exemplary contextual information may include defensive matchup information (e.g., who is guarding who at each frame, defensive formations), as well as other defensive information such as coverages for ball-screens or presses.

In some embodiments, to measure influence, the tracking data system may use a measure referred to as an “influence score.” The influences score may capture the influence a player may have on each other player on an opposing team on a scale of 0-100. In some embodiments, the value for the influence score may be based on sport principles, such as, but not limited to, proximity to player, distance from scoring object (e.g., basket, goal, boundary, etc.), gap closure rate, passing lanes, lanes to the scoring object, and the like.

Referring again to FIG. 5, at step 510, a plurality of event data associated with the real-time broadcast may be received. According to embodiments disclosed herein, event data may be generated based on tracking data and/or content feeds (e.g., in-venue video feeds, broadcast feeds, pre-recorded clips, application programming interface (API) feed, etc.). For example, tracking data may be generated by providing a content feed to one or more machine-learning models. The one or more machine-learning models may identify players and/or objects in the content feed and convert them to digital representations. The digital representations of the players and/or objects and their respective positions may be tracked to identify tracking data such as movement data (e.g., changes in the positions), changes in movement, trends, etc. Such information may be used by a generative machine-learning model, or any machine-learning or artificial intelligence model as disclosed herein.

At step 515, the plurality of tracking data and the plurality of event data may be provided to the generative machine-learning model. As disclosed herein, the generative machine-learning model may be informed by sports data. The generative machine-learning model may be trained to identify associations between the plurality of tracking data and the plurality of event data and generate live commentary for the real-time broadcast. In embodiments, the live commentary may be generated in real-time as a broadcast is occurring. In other examples, the live commentary may be generated and stored as clips for later viewing. The tracking data may be analyzed by the machine-learning models to determine correlations between the tracking data and event types (e.g., goal scored, pass made, play types, etc.). For example, tracking data may be used to determine when a digital representation of an object (e.g., a ball) crosses a scoring object (e.g., a goal post). Based on such determination, an event type of a goal scored may be identified. Further, the digital representation of the player(s) that contacted the object (e.g., ball) prior to the goal scored event may be identified as the player(s) that contributed to or otherwise caused the event (e.g., goal). Accordingly, content feeds may be used to generate tracking data which may further be used to determine event data corresponding to certain sports events. In various embodiments, a plurality of contextual data associated with the real-time broadcast may be provided to the machine-learning model. In examples, the contextual data may include statistics, API data feeds, audio feeds, live summaries of statistics, and/or generated insights (e.g., momentum, etc.), and the like.

At step 520, the live commentary may be provided to an output device of the computing system. In examples, the live commentary may be in a selected language (e.g., automatically selected, user selected, or the like). In other examples, the live commentary may be in a selected voice or accent, or based on an input voice, or the like (e.g., using one-shot machine-learning). In one embodiment, an avatar may be generated to deliver the live commentary, such as by a human likeness via the live feed.

In various embodiments, a speech-to-speech machine-learning model may be implemented. In such implementations, end-to-end architectures may directly convert source speech (e.g., commentary) into target speech without the intermediate steps associated with converting the source speech to text, as discussed herein. In these embodiments, the inputs to a speech-to-speech machine-learning model may include recorded or captured speech. The output from such models may include a machine generated audio output generated, at least in part, based on the recorded or captured speech input.

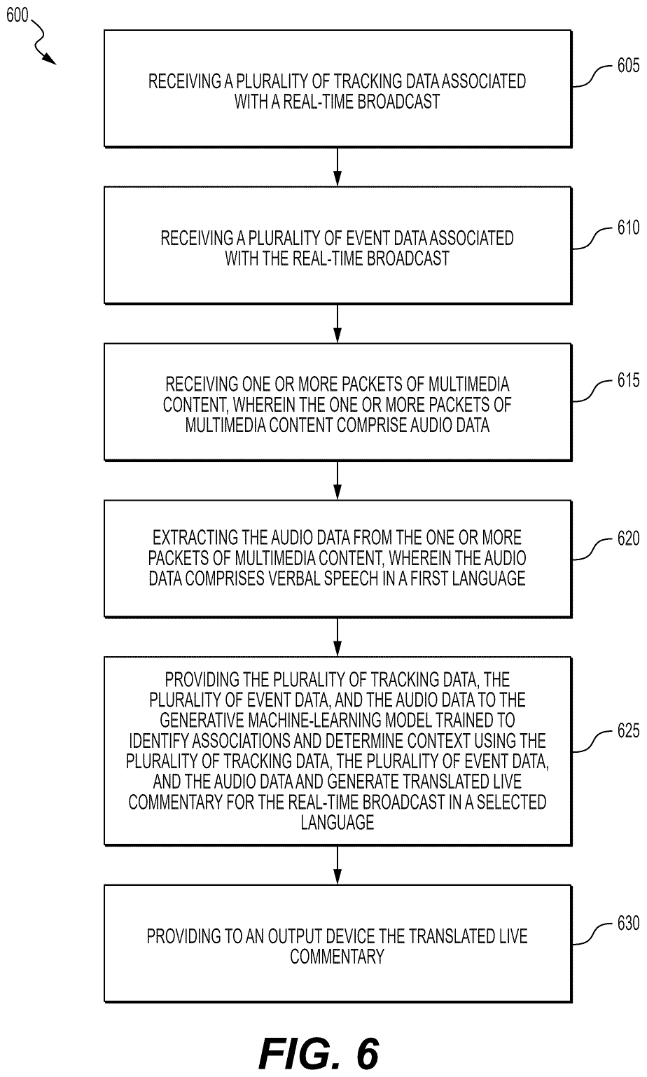

FIG. 6 depicts an exemplary method 600 of generating translated live commentary using a generative machine-learning model. At step 605, a plurality of tracking data associated with a real-time broadcast may be received. At step 610, a plurality of event data associated with the real-time broadcast may be received. At step 615, one or more packets of multimedia content may be received. In examples, the one or more packets of multimedia content may include audio data. At step 620, the audio data may be extracted from the one or more packets of multimedia content. In examples, the audio data may include verbal speech in a first language. At step 625, the plurality of tracking data, the plurality of event data, and the audio data may be provided to the generative machine-learning model. In various embodiments, the generative machine-learning model may be trained to identify associations and determine context using the plurality of tracking data, the plurality of event data, and the audio data and generate translated live commentary for the real-time broadcast in a selected language. At step 630, the translated live commentary may be provided to an output device of the computing system.

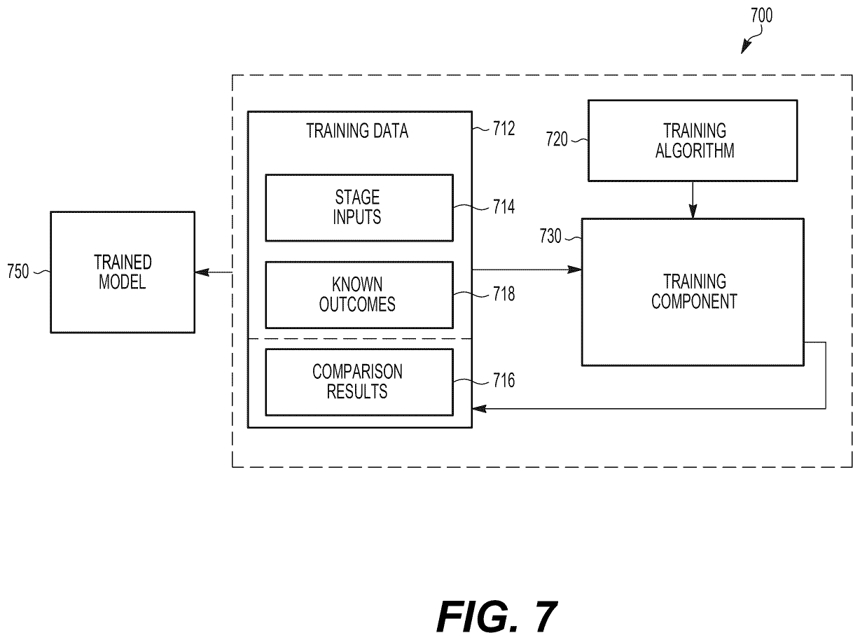

FIG. 7 depicts a flow diagram for training a machine-learning model. As shown in flow diagram 700 of FIG. 7, training data 712 may include one or more of stage inputs 714 and known outcomes 718 related to a machine-learning model to be trained. The stage inputs 714 may be from any applicable source including a component or set shown in the figures provided herein. The known outcomes 718 may be included for machine-learning models generated based on supervised or semi-supervised training. An unsupervised machine-learning model might not be trained using known outcomes 718. Known outcomes 718 may include known or desired outputs for future inputs similar to or in the same category as stage inputs 714 that do not have corresponding known outputs.

The training data 712 and a training algorithm 720 may be provided to a training component 730 that may apply the training data 712 to the training algorithm 720 to generate a trained machine-learning model 750. According to an implementation, the training component 730 may be provided comparison results 716 that compare a previous output of the corresponding machine-learning model to apply the previous result to re-train the machine-learning model. The comparison results 716 may be used by the training component 730 to update the corresponding machine-learning model. The training algorithm 720 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 700 may be a trained machine-learning model 750.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

It should be understood that aspects in this disclosure are exemplary only, and that other aspects may include various combinations of features from other aspects, as well as additional or fewer features.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

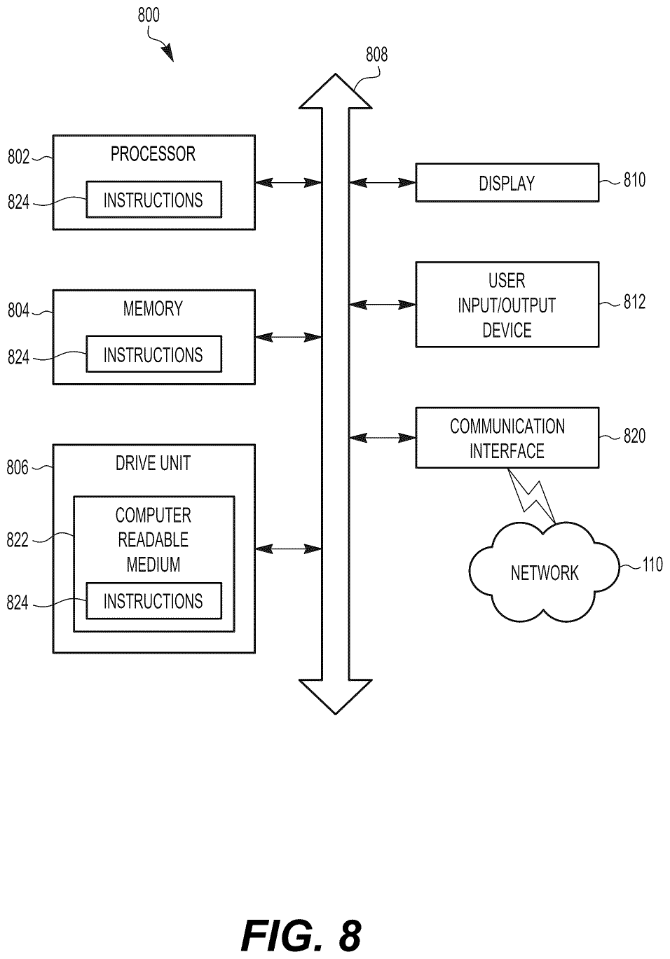

FIG. 8 is a simplified functional block diagram of a computer 800 that may be configured as a device for executing the methods disclosed here, according to exemplary aspects of the present disclosure. For example, the computer 800 may be configured as a system according to exemplary aspects of this disclosure. In various aspects, any of the systems herein may be a computer 800 including, for example, a data communication interface 820 for packet data communication. The computer 800 also may include a central processing unit (“CPU”) 802, in the form of one or more processors, for executing program instructions. The computer 800 may include an internal communication bus 808, and a storage unit 806 (such as ROM, HDD, SDD, etc.) that may store data on a computer readable medium 822, although the computer 800 may receive programming and data via network communications.

The computer 800 may also have a memory 804 (such as RAM) storing instructions 824 for executing techniques presented herein, for example the systems and methods described with respect to FIGS. 1-7, although the instructions 824 may be stored temporarily or permanently within other modules of computer 800 (e.g., processor 802 and/or computer readable medium 822). The computer 800 also may include input and output ports 812 and/or a display 810 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed aspects may be applicable to any environment, such as a desktop or laptop computer, an automobile entertainment system, a home entertainment system, etc. Also, the disclosed aspects may be applicable to any type of Internet protocol.

It should be appreciated that in the above description of exemplary aspects of the invention, various features of the invention are sometimes grouped together in a single aspect, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed aspect. Thus, the claims following the Detailed Description are hereby expressly incorporated into this Detailed Description, with each claim standing on its own as a separate aspect of this invention.

Furthermore, while some aspects described herein include some but not other features included in other aspects, combinations of features of different aspects are meant to be within the scope of the invention, and form different aspects, as would be understood by those skilled in the art. For example, in the following claims, any of the claimed aspects can be used in any combination.

Thus, while certain aspects have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Operations may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for extracting and processing audio data, the method comprising:
receiving, by a computing system, one or more packets of multimedia content, wherein the one or more packets of multimedia content comprise audio data;
extracting, by the computing system, the audio data from the one or more packets of multimedia content, wherein the audio data comprises verbal speech in a first language;
converting, by the computing system, the audio data into first text data in the first language based on the verbal speech in the first language;
providing, by the computing system, the first text data to a generative machine-learning model trained to translate the first text data in the first language to a second language and generate second text data in the second language; and
transmitting, to a user interface by the computing system, the second text data in the second language.

2. The method of claim 1, wherein the audio data is converted into first text data using closed captioning data included in the one or more packets of multimedia content.

3. The method of claim 1, wherein the generative machine-learning model is an artificial intelligence model trained to translate text data into a plurality of languages.

4. The method of claim 1, further comprising:
converting, by the computing system, the second text data in the second language to translated audio data; and
merging, by the computing system, the translated audio data with video data of the one or more packets of multimedia content.

5. The method of claim 1, further comprising:
providing, by the computing system, the first text data to a rephrasing machine-learning model trained to rephrase the first text data in the first language to one or more strings of text data in a second language and generate rephrased second text data in the second language; and
transmitting, to a user interface by the computing system, the rephrased second text data in the second language.

6. The method of claim 1, wherein the one or more packets of multimedia content comprise at least one of audio data, video data, text data, story data, or live feed data.

7. The method of claim 1, wherein the one or more packets of multimedia content are included within at least one of a JSON file, an audio file, a video file, a story file, or a text file.

8. The method of claim 1, wherein the one or more packets of multimedia content are received by the computing system in real time.

9. The method of claim 1, wherein the one or more packets of multimedia content are stored in a data store and are retrieved by the computing system.

10. The method of claim 1, further comprising:
providing, by the computing system, the first text data to a predictive machine-learning model trained to identify language patterns in the first text data in the first language and generate second text data in the second language based on the identified language patterns; and
transmitting, to a user interface by the computing system, the second text data in the second language.

11. A system for extracting and processing audio data, the system comprising:
a memory storing instructions and a generative machine-learning model trained to translate first text data in a first language to a second language and generate second text data in the second language; and
a processor operatively connected to the memory and configured to execute the instructions to perform operations including:
receiving, by a computing system, one or more packets of multimedia content, wherein the one or more packets of multimedia content comprise audio data;
extracting, by the computing system, the audio data from the one or more packets of multimedia content, wherein the audio data comprises verbal speech in the first language;
converting, by the computing system, the audio data into the first text data in the first language based on the verbal speech in the first language;
providing, by the computing system, the first text data to the generative machine-learning model; and
transmitting, to a user interface by the computing system, the second text data in the second language.

12. The system of claim 11, wherein the audio data is converted into first text data using closed captioning data included in the one or more packets of multimedia content.

13. The system of claim 11, wherein the generative machine-learning model is an artificial intelligence model trained to translate text data into a plurality of languages.

14. The system of claim 11, further comprising:
converting, by the computing system, the second text data in the second language to translated audio data; and
merging, by the computing system, the translated audio data with video data of the one or more packets of multimedia content.

15. The system of claim 11, further comprising:
providing, by the computing system, the first text data to a rephrasing machine-learning model trained to rephrase the first text data in the first language to one or more strings of text data in a second language and generate rephrased second text data in the second language; and
transmitting, to a user interface by the computing system, the rephrased second text data in the second language.

16. The system of claim 11, wherein the one or more packets of multimedia content comprise at least one of audio data, video data, text data, story data, or live feed data.

17. The system of claim 11, wherein the one or more packets of multimedia content are received by the computing system in real time.

18. The system of claim 11, wherein the one or more packets of multimedia content are stored in a data store and are retrieved by the computing system.

19. The system of claim 11, further comprising:
providing, by the computing system, the first text data to a predictive machine-learning model trained to identify language patterns in the first text data in the first language and generate second text data in the second language based on the identified language patterns; and
transmitting, to a user interface by the computing system, the second text data in the second language.

20. A method for extracting and processing audio data, the method comprising:
receiving, by a computing system, one or more packets of multimedia content, wherein the one or more packets of multimedia content comprise audio data;
extracting, by the computing system, the audio data from the one or more packets of multimedia content, wherein the audio data comprises verbal speech in a first language;
converting, by the computing system, the audio data into first text data in the first language based on the verbal speech in the first language;
providing, by the computing system, the first text data to a rephrasing machine-learning model trained to rephrase the first text data in the first language to one or more strings of text data in a second language and generate rephrased second text data in the second language; and
transmitting, to a user interface by the computing system, the rephrased second text data in the second language.
